(19) United States
(12) Patent Application Publication
(10) Pub. No.: US 2022/0062073 A1
(43) Pub. Date: Mar. 3, 2022

(54) TRANSPORT DEVICE

(71) Applicant: R.E.D.D. SLED, LLC, West Des Moines, IA (US)

(72) Inventors: Andrew Kossoff, West Des Moines, IA (US); Allen Rodriguez, Pleasant Hill, IA (US)

(21) Appl. No.: 17/003,360

(22) Filed: Aug. 26, 2020

(51) Int. Cl. A61G 1/01; A61G 1/044; A62B 5/00; A61G 1/003

(52) U.S. Cl. CPC A61G 1/01; A61G 1/003; A62B 5/00; A61G 1/044

(57) ABSTRACT

A transport device having a layer of fire resistant fabric connected to a layer of plastic. A plurality of hooks are connected to the ends of the layer of fabric and a plurality of rings and handles are connected to the sides of the layer of fabric.

### BACKGROUND OF THE INVENTION

This invention is directed to a transport device and more particularly to a device for transporting an individual quickly over difficult terrain.

Transport devices, such as a sked board, are known in the art. These devices are not designed for use in fire, military, or emergency situations where quick and safe removal from a dangerous situation is necessary. Further, these devices typically are not suitable for use with bariatric patients. Most of these devices are designed for lifting an individual as opposed to dragging. Therefore, a need exists in the art for a device that can address these deficiencies.

An objective of the present invention is to provide a transport device capable of traversing difficult terrain.

Another objective of the present invention is to provide a transport device for the quick and safe removal of an individual.

These and other objectives will be apparent to those skilled in the art based upon following written description and drawings.

### SUMMARY OF THE INVENTION

A transport device for the quick and safe removal of an individual from a dangerous situation includes a layer of fire resistant fabric attached to a layer of plastic. The fabric has a plurality of hooks attached to the ends of the fabric, and a plurality of rings and handles attached to the sides. An adjustable strap is also attached to a side.

A carrier for holding the device in a rolled up position has a longitudinal strap. Connected to the longitudinal strap is a pair of transverse straps, a handle, and bags.

### BRIEF DESCRIPTION OF THE DRAWINGS

FIG. 1 is a top plan view of a transport device;

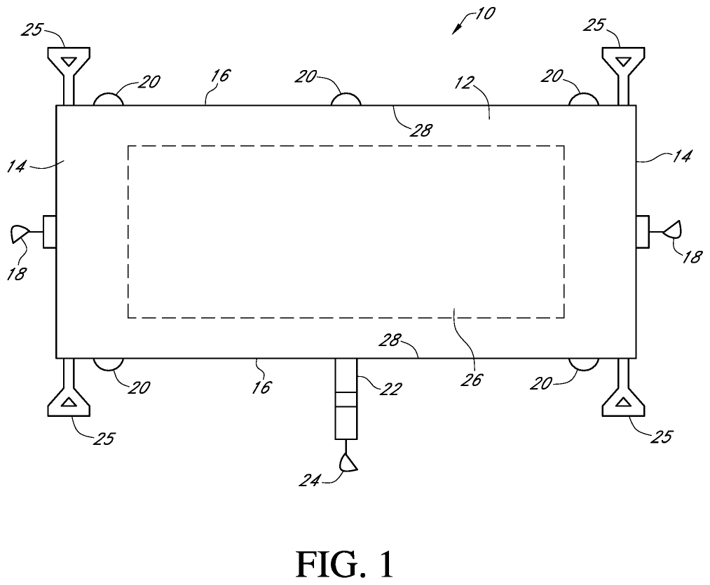

FIG. 2 is a side view of a carrier and a transport device; and

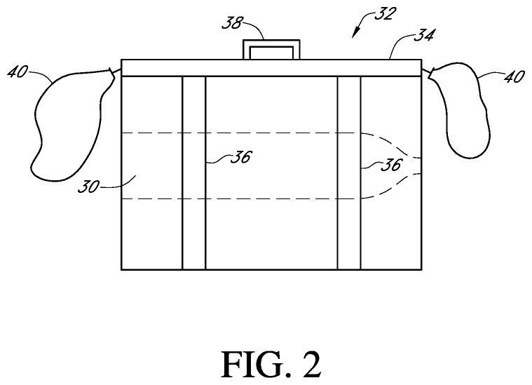

FIG. 3 is a bottom plan view of a transport device.

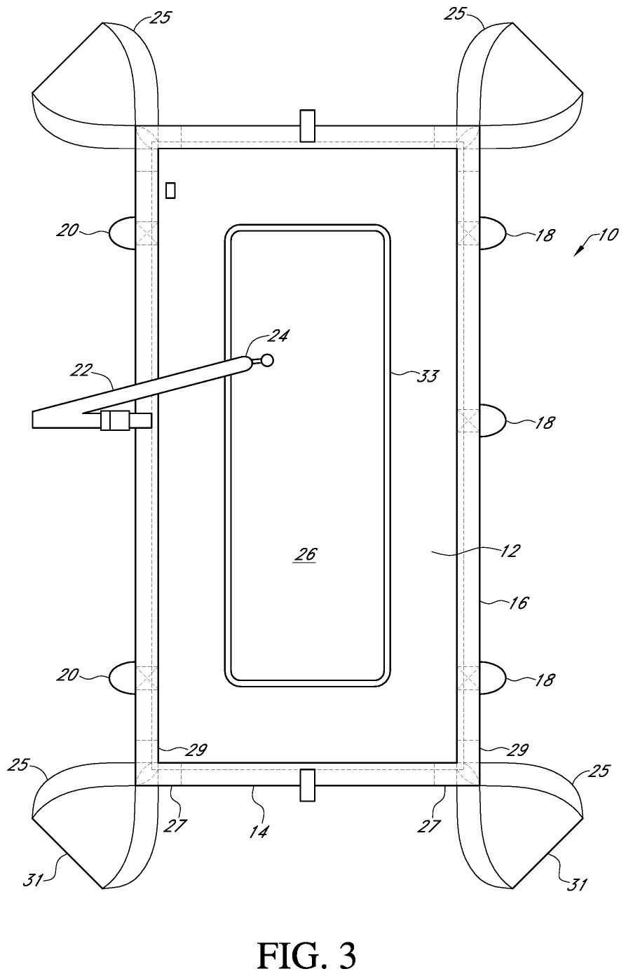

### DETAILED DESCRIPTION

Referring to the figures, a transport device 10 has a layer of resilient fabric 12 that preferably is rectangular in shape and is made of a fire resistant material. The layer of fabric 12 has ends 14 and sides 16. Attached to each end 14 is a hook or clip 18 and attached along the sides 16 are a plurality of rings or clasps 20. Preferably the clips 18 are of a type that are easily attached to the clasp 20 while wearing gloves, and in particular, fire or heat resistant gloves. An adjustable strap 22 is attached to a side 16 at one end and has a hook or a clip 24 at the opposite end. A plurality of handles 25 are connected to the corner of sides 16 adjacent each end 14. Preferably, the handles 25 are made of a single strap with about four inches of one end 27 attached to an end 14 and the opposite end 29 having about four inches attached to the side 16. The strap extends about two feet from the corner so one does not have to bend over when dragging the transport device 10. Also, the strap 25 extends through a hard plastic hollow tube 31 to permit one wearing gloves to easily grasp the handle 25.

Attached to an outer surface of the material 12 is a layer of plastic 26 capable of being rolled into a cylinder. Preferably the layer of plastic 26 is made of high density polyethylene. The layer of plastic 26 is positioned inwardly from an outer edge 28 of the layer of fabric 12 so that the outer edge 28 may be folded inwardly. Preferably, the layer of plastic 26 is stitched to the layer of fabric 12 and a strip of material 33 is attached to cover the stitching and prevent damage when the transport device is dragged. In one example, the layer of material is made of Kevlar.

In a storage position, the layer of fabric 12 and plastic 26 are rolled around an air canister or self-contained breathing apparatus 30 to form a cylinder. The rolled cylinder is held in place with a carrier 32 having a longitudinal strap 34 and a pair of transverse straps 36, connected to strap 34, that wrap around the rolled cylinder and are fastened at opposite ends by a fastening means such as a hook and loop system. Connected to the elongated strap 34 is a handle 38. At the ends of the longitudinal strap, bags 40 attached for carrying a tag-line, a free mask replacement, or the like.

In operation, the transport device 10 is carried into a fire area using handle 38. The end of straps 36 are released and the fabric and plastic layers 12 and 26 are rolled out to lay generally flat with the plastic layer 26 engaging the ground. A fire victim's body is rolled onto the fabric layer 12. The rings 20 at the feet of the victim are folded inwardly and connected by a clip 18 to form a pocket that receive a victim's feet. The sides 16 are folded in and the device 10 is adapted to completely wrap around the fire victim's body. The handles 25 adjacent the head of the victim are lifted and the victim is able to be dragged out of the fire area because the plastic layer is capable of sliding over stairs, objects, and debris. The whole process takes less than thirty seconds.

From the above discussion and accompanying figures and claims it will be appreciated that the transport device 10 offers many advantages over the prior art. It will be appreciated further by those skilled in the art that other various modification could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A transport device, comprising:
a layer of resilient fabric adapted to wrap completely around a fire victim's body;
a plurality of hooks connected to each end of the layer of fabric;
a plurality of rings connected along the sides of the layer of fabric; and
a layer of plastic attached to the layer of fabric.

2. The device of claim 1 wherein the layer of fabric is made of a fire resistant material.

3. The device of claim 1 wherein the layer of plastic is made from a high density polyethylene.

4. The device of claim 1 wherein the layer of plastic is positioned inwardly from an outer edge of the layer of fabric.

5. The device of claim 1 further comprising an adjustable strap attached to one of the sides of the layer of fabric at one end and a clip attached to the layer of fabric at the opposite end.

6. The device of claim 1 further comprising a plurality of handles connected to corners of the sides of the layer of fabric adjacent each end.

7. The device of claim 6 wherein the handles are connected to the sides and the ends of the layer of resilient fabric.

8. The device of claim 6 wherein the handles extend two feet from the corners of the layer of resilient fabric.

9. The device of claim 6 wherein the handles include a strap that extends through a hollow tube of hard plastic.

10. The device of claim 1 further comprising a carrier having a longitudinal strap that is connected to a pair of transverse straps and a handle.

11. The device of claim 7 wherein bags are attached to the longitudinal strap.

12. The device of claim 1 wherein a strip of material covers a portion of the layer of resilient material and the layer of plastic.

13. The device of claim 12 wherein the strip of material is made of Kevlar.
